(19) United States
(12) Patent Application Publication
(10) Pub. No.: US 2020/0304324 A1
(43) Pub. Date: Sep. 24, 2020

(54) TAMPER-PROOF PHYSICAL UNCLONABLE FUNCTION SEALS FOR AUTHENTICATION OF BOTTLES

(71) Applicant: LEXMARK INTERNATIONAL, INC., Lexington, KY (US)

(72) Inventors: SCOTT RICHARD CASTLE, LEXINGTON, KY (US); GARY ALLEN DENTON, LEXINGTON, KY (US); JAMES PAUL DRUMMOND, GEORGETOWN, KY (US); ANDREW CHRISTOPHER GARDNER, LEXINGTON, KY (US); KEITH BRYAN HARDIN, LEXINGTON, KY (US); KELLY ANN KILLEEN, LEXINGTON, KY (US); ROBERT HENRY MUYSKENS, LEXINGTON, KY (US); BRANT DENNIS NYSTROM, LEXINGTON, KY (US); GARY SCOTT OVERALL, LEXINGTON, KY (US)

(21) Appl. No.: 16/823,615

(22) Filed: Mar. 19, 2020

Related U.S. Application Data
(60) Provisional application No. 62/822,541, filed on Mar. 22, 2019.

(51) Int. Cl. H04L 9/32; B65D 41/34; G06K 7/14

(52) U.S. Cl. CPC H04L 9/3278; B65D 41/34; B65D 2313/10; B65D 2313/04; G06K 7/1417

(57) ABSTRACT

Wine and liquor bottles have a shrink-wrap seal, or other type, that is applied to the cap/cork end of the bottle. This seal material can be loaded with randomly magnetized particles, such as flakes of an alloy of neodymium, iron, and boron (“NdFeB”). The randomly magnetized particles provide a unique unclonable magnetic fingerprint to the bottle. The magnetic field may be recorded for one or more circumferential bands around the surface of the bottle's neck and used as a magnetic fingerprint to authenticate the bottle. Authentication can be performed by inserting the bottle in an appropriate fixture, which measures the magnetic fingerprint.

### CROSS REFERENCES TO RELATED APPLICATIONS

U.S. patent application Ser. No. ______, titled “Multi-Factor Physically Unclonable Function Key, Coin, or RFID.”

### PRIORITY CLAIM FROM PROVISIONAL APPLICATION

The present application is related to and claims priority under 35 U.S.C. 119(e) from U.S. provisional application No. 62/822,541, filed Mar. 22, 2019, titled “Tamper-Proof PUF Seals for Authentication of Bottles,” the content of which is hereby incorporated by reference herein in its entirety.

### BACKGROUND

The present disclosure relates generally to anti-counterfeiting technology in the fields of wine, spirits, packaging seals, and labels.

Certain types of products tend to be more attractive to counterfeiters than others—wines and spirits meet both key criteria having strong brands, premium pricing, and high levels of taxation. According to European Union Intellectual Property Office, almost €2.8B in sales was lost in 2018 across Europe due to counterfeiting in the wine and spirits industry. Moreover, according to market analysts, 20% of wine sold worldwide is counterfeit, rising to 50% in some countries.

Two European firms have launched anti-counterfeiting technology designed to stop bottles of wines and spirits from being illicitly refilled. The technology—called CapSeal®—has been developed by Inside Secure of France and Selinko of Belgium, and uses a near-field communication (“NFC”) tag. The NFC tag is incorporated within a capsule that seals the neck of the bottle to make it possible to tell if it has previously been opened.

A case study published by De La Rue teaches: “The Eddington Group, makers of world renowned ‘The Macallan Highland Single Malt Scotch Whisky,’ faced a challenge when re-filled used bottles, intact with labels, began appearing on shelves under their brand name. This posed a serious consumer safety, as well as a global brand issue.”

For a solution, the distiller added a tamper-proof holographic security label from De La Rue to their bottles to fight the counterfeiting problem. Holograms, however, can be copied, so it is unclear how long this solution will last. A more secure unclonable authentication method is needed to block the refilling of empty bottles for high dollar wines and spirits or any packaging that has a distinct interface for opening the package.

### SUMMARY

The invention described is a label, seal, component or package that contains a physically unclonable function (PUF) that has a tamper proof indication if disturbed. The tamper characteristic is evident from a visual or sensing method over the surface. The application of the tamper proof function is intended for use on higher value objects including wine, spirits or packaging.

### BRIEF DESCRIPTION OF THE DRAWINGS

The above-mentioned and other features and advantages of the disclosed embodiments, and the manner of attaining them, will become more apparent and will be better understood by reference to the following description of the disclosed embodiments in conjunction with the accompanying drawings.

FIG. 1 shows a bottle with shrink sleeve.

FIG. 2 shows a screw cap with tamper ring.

FIG. 3A shows a physical unclonable function seal label and also 3B on bottle.

FIG. 4A shows a physical unclonable function material cross section with one sided release layer and 4B tampered.

FIG. 5A shows a physical unclonable function material cross section with two-sided release layers and 5B tampered.

FIG. 6A shows a multifactor physical unclonable function material and 6B cross section.

FIG. 7 shows a physical unclonable function material label with removable sections.

### DETAILED DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting. As used herein, the terms “having,” “containing,” “including,” “comprising,” and the like are open ended terms that indicate the presence of stated elements or features, but do not preclude additional elements or features. The articles “a,” “an,” and “the” are intended to include the plural as well as the singular, unless the context clearly indicates otherwise. The use of “including,” “comprising,” or “having,” and variations thereof herein is meant to encompass the items listed thereafter and equivalents thereof as well as additional items.

Terms such as “about” and the like have a contextual meaning, are used to describe various characteristics of an object, and such terms have their ordinary and customary meaning to persons of ordinary skill in the pertinent art. Terms such as “about” and the like, in a first context mean “approximately” to an extent as understood by persons of ordinary skill in the pertinent art; and, in a second context, are used to describe various characteristics of an object, and in such second context mean “within a small percentage of as understood by persons of ordinary skill in the pertinent art.

Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. Spatially relative terms such as “top,” “bottom,” “front,” “back,” “rear,” and “side,” “under,” “below,” “lower,” “over,” “upper,” and the like, are used for ease of description to explain the positioning of one element relative to a second element. These terms are intended to encompass different orientations of the device in addition to different orientations than those depicted in the figures. Further, terms such as “first,” “second,” and the like, are also used to describe various elements, regions, sections, etc., and are also not intended to be limiting. Like terms refer to like elements throughout the description.

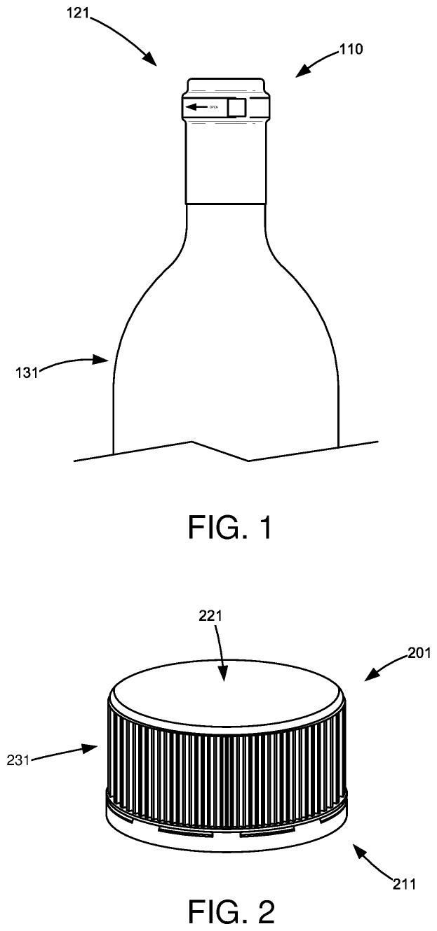

Many wine bottles have a shrink-wrap seal 110 applied to the cap/cork end 121 of the bottle 131 as shown in FIG. 1. This shrink-wrap material can be loaded with randomly magnetized particles, such as flakes of an alloy of neodymium, iron, and boron (“NdFeB”) or an alloy of samarium and cobalt (“SmCo”) as taught in U.S. Pat. No. 9,553,582 titled “Physical Unclonable Function Having Magnetic and Non-Magnetic Particles,” the content of which is hereby incorporated by reference herein in its entirety. The randomly magnetized particles provide a unique unclonable magnetic fingerprint to the top of the bottle. The magnetic field may be recorded for one or more circumferential bands around the surface of the bottle's neck and used as a magnetic fingerprint to authenticate the bottle. Conversely, a flexible surface magnetic field reading device is curved around the cylinder. Authentication can be performed by inserting the bottle in a kiosk-type fixture, or other appropriate fixture, which measures the magnetic fingerprint as the bottle is rotated for one to two, or more, revolutions or read directly over an arc. These kiosk-type fixtures could be placed in retail establishments, for example, for use each time a bottle needs to be authenticated.

In a first embodiment, the kiosk-type fixture has a rotatable surface at the base that the bottle of wine is placed and centered on. A rotary encoder attached to the shaft under the rotating surface provides rotation angle values for association with the magnetic field readings when the bottle is authenticated. One or more magnetic sensors, preferably 3-axis sensors, are advanced into near contact with the PUF tamper proof seal near the top of the bottle. The bottle is rotated sufficiently to establish a magnetic field profile, preferably 360 degrees, and the magnetic profile is recorded for each axis/component of the magnetic field. The measured profiles are processed and compared against the enrollment data to authenticate the bottle. The processing of the authentication data may take place on a remote server that has access to the enrollment test values for each PUF-protected bottle. The bottle labeling may also contain a bar code or a quick response (“QR”) code that identifies the brand of wine and the bottle's serial number. This information may be read by a digital camera or other sensor, optical or otherwise, to identify the serial number of the bottle being authenticated. The serial number may then be used by the remote server to select the enrollment data file for this bottle

In a second embodiment, the bottle remains stationary, and one or more sensors are located on or moved across the surface of the magnetic PUF seal material. This motion could be around the surface of the bottle neck, along the length of the bottle neck, or along any other appropriate surface of the bottle according to the location of the magnetic PUF seal material. Measuring the fingerprint in a circular path is typically preferred because it would require less data storage than measuring along other paths since it allows a continuous read in a known location. Other paths will require additional registering of the starts and stops with path information.

In a third embodiment, the bottle is laid horizontally on rollers, or other similar device or mechanism, and rotated about the axis of the bottle while the magnetic fingerprint signals are collected from a stationary sensor location.

In a fourth embodiment, a magnetic PUF disk could be attached to the top or bottom of the bottle for authentication where a preferably flat surface is present.

When the bottle is authenticated, information is transmitted back to the kiosk-type fixture confirming the authenticity of the bottle, and a brief report or certificate of authenticity may be either displayed on a screen or printed for the customer to take away with the bottle. The report information could include details such as the bottle's serial number, vineyard location, barrel number, bottling location, bottling date, etc. The authentication report could also show all previous authentication records (time, place, authentication location, identification of the authentication kiosk-type fixture, etc.). This information would act to discourage refilling while allowing the retailer to authenticate bottles when they are received from any source.

In a similar fashion, this invention could be applied to bottles of spirits like vodka, gin, bourbon, etc. It could also be applied to the authentication of bottles containing prescription medicines, or any other packaged product needing authentication.

In a fifth embodiment, a tamper-evident cap 201 such as shown in FIG. 2 could be molded with magnetic flakes in the flat top of the cap 221. This fingerprint could be read during rotation of the bottle either on the side 231 or top 221, or in a stationary reader using an array of magnetic sensors. The cap bottom 211 separates from the top 221 when the top is removed leaving magnetic particles disturbing and separating from their original location.

It should be recognized that a handheld magnetic sensing device containing an array of magnetic sensing elements could be used to scan the magnetic PUF seal material in any of the previously mentioned potential embodiments. The user operation of the handheld magnetic sensing device could be similar to the traditional user experience of a handheld 2D optical barcode scanner. However, instead of capturing optical barcode data, when the handheld magnetic scanner is placed in stationary contact with the PUF seal material an array of magnetic sensors within the reader capture magnetic data at points along the surface of the tag. The sensor builds a “map” of the magnetic field strengths seen at each sensing element. This sensed magnetic data map is then compared against a previously enrolled magnetic field map, taken at the original time of product manufacturing, to determine if the magnetic “fingerprint” is authentic. In the event that the magnetic PUF seal material had been tampered with, the magnetic fingerprint collected by the magnetic array sensing device would not match the magnetic data map (fingerprint) that had been recorded at the time of original manufacturing, i.e., prior to the tampering.

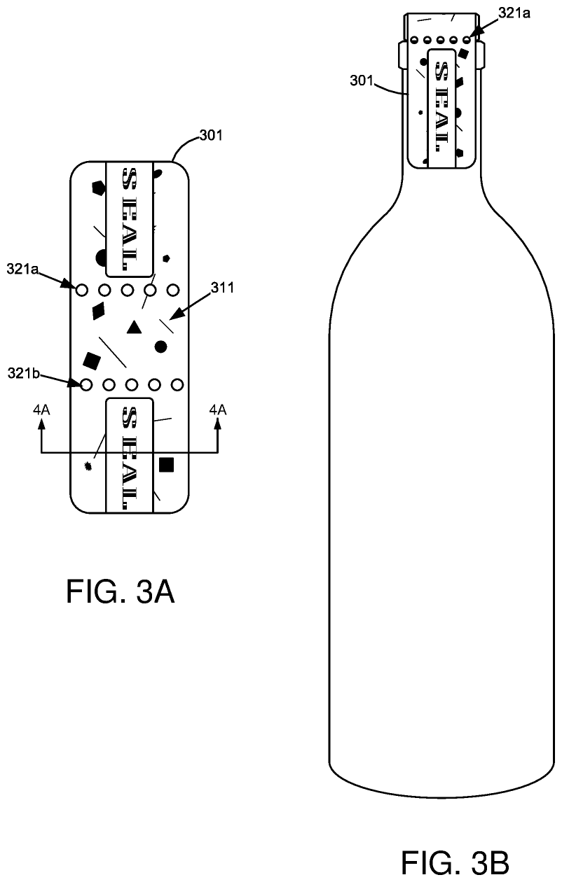

This invention is an application of PUF material into a tamper proof label or seal resulting in a multifactor authentication. The seal has the property that gives it a unique signature over the surface that can be characterized in a predetermined state or after installation of the object that is being sealed for authentication. FIG. 3 shows a tamper proof label for sealing an object. The label 301 is shown with the word “SEAL.” The label integrates a Physically Unclonable Function (PUF) material 311 that creates a unique fingerprint that can be interrogated by a sensor device (not shown). The PUF material is distributed, randomly oriented, and dense enough to make it impractical to copy. The density is also such that if any part is removed then it can be proven that the label has been tampered with. Another feature is that the PUF material is configured such that if it is removed from the object parts of the label is separated leaving some PUF material on the object and other on the label. The structure will be disturbed because of the removal in a way that caused the PUF material to be altered if it is attempted to be resealed. This makes it obvious that the label has been tampered. The solid shapes represent the PUF material. These particles are also distributed through the “SEAL” word area as well.

The label has multiple layers that facilitate the tamper function of the label. A substrate may be used as a durable surface of the label. The material may be vinyl, PET, polyester, acrylic, paper or other rigid or flexible material. The authentication may be by human or electronic inspection. The label has additional features to facilitate the breaking of the seal to indicate the tamper. FIG. 3A shows two rows of circles 321A, 321B that are punched areas that become a tear location when the cap is removed. Other means may be used to stress, relax or score a line to create a tear location as a substitute for the punched areas.

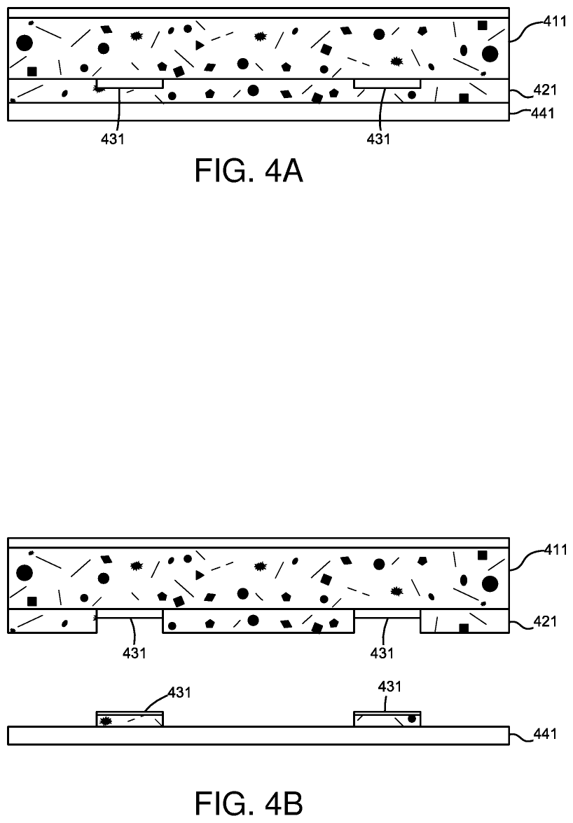

FIG. 4A shows a cross section of the label in FIG. 3A along the 4A-4A line.

The rigid or film substrate is the upper layer 411 of the label that contains PUF material. The next layer down is an adhesive layer 421 with the PUF material distributed within the adhesive. There is an optional release layers 431 that causes the adhesive to separate at lower force levels than to remove the remaining areas of the label. The label is affixed to the object or package 441. The release layers may be positioned at different locations within the layers. A key feature of this label is that the substrate can be uniquely enrolled. The adhesive can be characterized and enrolled with the label substrate as well. This allows forensic evaluation of the label before and after separation. FIG. 4B shows the resulting separation leaving some of the adhesive 431 on the substrate and some on the object or package 441.

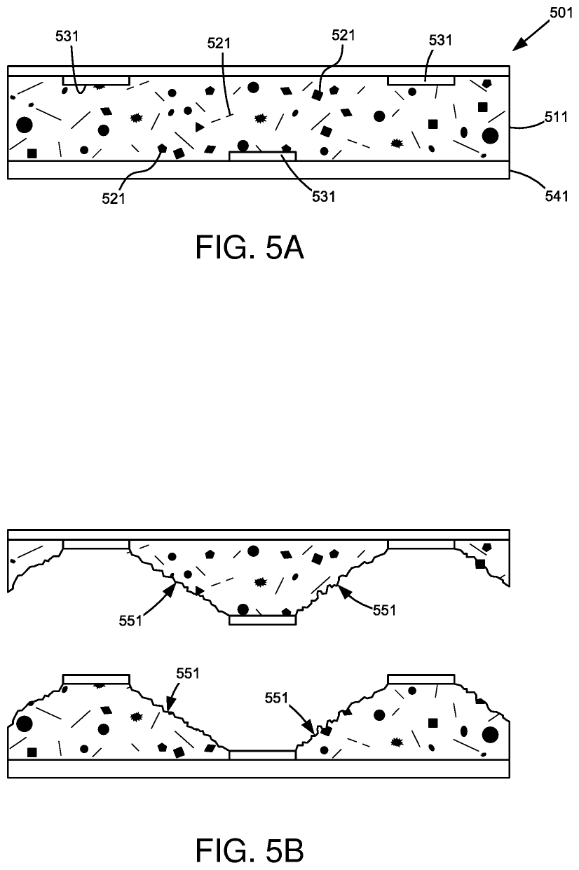

FIG. 5A shows an option where the adhesive 511 is the only layer that contains the PUF material. This is a lower cost solution, but it does not have the ability to uniquely identify the substrate. The release layers 531 constitute points of weakness to initiate the separation when the label surface 501 is pulled to initiate the separation. The PUF material 521 can be comprised of particles with a relative permeability of greater than one. These may be hard or soft magnetic material. In the case of hard magnetic material, they may be de-magnetized or pre-magnetized. To create the multifactor authentication other PUF material may be present. These would include optical fibers, coated copper or aluminum wires. The optical fibers or wire would work in a best mode if their length were several times the thickness of the substrate. This would allow a source of light or voltage probe to couple energy into the substrate and translate the energy to a random location along the substrate. This can be detected by a photo or capacitive sensor. By having multiple factors, different authentication methods can be applied increasing the entropy of the system.

FIG. 5B shows the label surface 501 separated from the object or package 541. The separation initiates at the release layers 531 and ruptures the adhesive layer 511, leaving the torn surfaces 551.

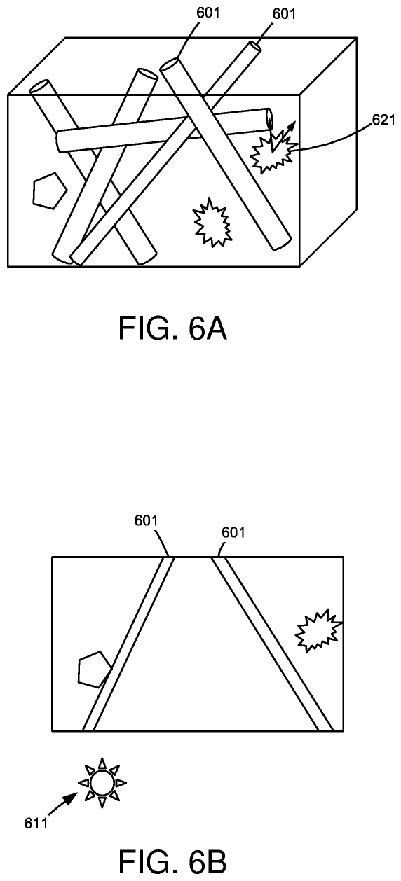

The addition of fiber-like structures to the magnetic particles 621 creates an added feature of bridging the separation locations of the tag. The fibers may be pulled out of the adjacent material along the separation line. The breaking or dislocation of these fibers make it impossible to reassemble the label and keep the original enrollment data consistent. FIGS. 6A, 6B show an adhesive or substrate material with optical fibers 601 integrated with the particles, and a light source 611.

Preferably, the fibers may be pulled out of the matrix or break in a way that they will no longer perform the authentication function if reassembled.

Additional evidence of tampering may be provided by selecting a film substrate with modulus lower than the cohesive and/or adhesive strength of the adhesive layer such that the shape of the film and thus the relative distribution of PUF material within the film is readily distorted when removed. The PUF object may be reflow material like a wax that has the matrix material.

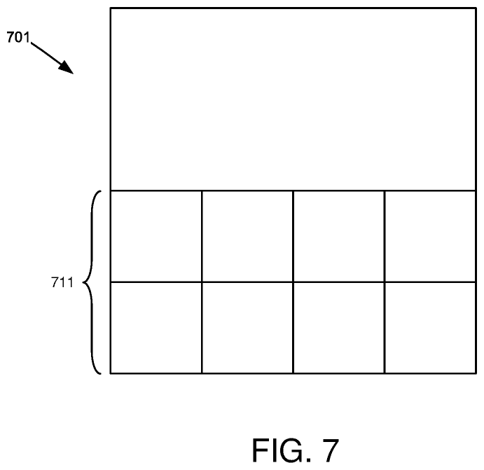

FIG. 7 shows a label with removable sections 711 that indicate a use of the stored contents. The label has a reserved section 701 that represents a quanta of the stored information. FIG. 7 shows a label or seal that is partitioned into various areas. The top larger area 701 is intended to be a permanent label area with the PUF material located within some area. The construction would be like that of the label in FIGS. 3 and 5 where the PUF is designed to be attached to the packaging. The smaller areas at the bottom are tear-away or lift off sections that represent use and validation of use. For each use of the package, the tear-away 711 would represent a token. This token would authenticate that the use was from a package. The token may be fully transferred to the user or only a partial separation may be used. The entire label is enrolled into the data base. In case of dispute the permanent PUF material left on the package may be analyzed with the tear away token to guarantee that there is a match.

This security label can be applied to an array of packages at a time. For example, FIG. 7 may be on several pill detachable segments of a larger container package. By tearing away a pill section the individual pill may be validated later as coming from the parent package.

PUF material is imbedded in an electro-active polymer that will be deformed if an electric potential is applied. The application electric potential will migrate the particles by displacing the material and changing the position of the PUF particles. The material can be enrolled in various states so that the correct potential must be applied to validate the object.

A self-destructing object is created by choosing a matrix that is thermally sensitive, which allows the particles to migrate. Moisture, shock displacement, UV, air exposure, chemical, electrical, or other stimulus may change the object from the enrollment data. This method would be used to invalidate any label due to expiration or recall of material within the package. In this manner, users in the supply chain could reject labels that were invalidated.

The above invention is not limited to applied labels. The layering process can be integrated into any process that makes the label part of a package or device. The process may be integrated into a molding or extrusion process to make a replacement or original part of a larger device. The tokens be used to authenticate a repair or assembly of a collection of critical devices.

The foregoing description of embodiments has been presented for purposes of illustration. It is not intended to be exhaustive or to limit the present disclosure to the precise steps and/or forms disclosed, and obviously many modifications and variations are possible in light of the above teaching. It is intended that the scope of the invention be defined by the claims appended hereto.

We claim:

1. A tamper proof label or seal resulting in a multifactor authentication comprising:
a label that integrates a magnetic physically unclonable function (PUF) material in a particle form that creates a magnetic field, or magnetic fingerprint, that can be interrogated by a sensor device, wherein the PUF material is distributed and dense enough to make it impractical to copy;
the PUF material configured such that if it is removed from the object parts of the label is separated leaving some PUF material on the object and other on the label;
multiple layers in the label; and
a substrate that is a durable portion of the label, wherein the material may be vinyl, PET, polyester, acrylic, paper or other rigid or flexible material.

2. The tamper proof label or seal of claim 1, wherein the magnetic field may be recorded for one or more circumferential bands around the surface of the bottle's neck and used as a magnetic fingerprint to authenticate the bottle.

3. The tamper proof label or seal of claim 1, wherein the particles contain an alloy of neodymium, iron, and boron.

4. The tamper proof label or seal of claim 1, wherein the particles contain an alloy of samarium and cobalt.

5. The tamper proof label or seal of claim 1, wherein the label or seal may also contain a bar code or a quick response (“QR”) code that identifies the brand of wine and the bottle's serial number.

6. A method of bottle authentication comprising the steps of:
applying a label to the bottle that integrates a magnetic physically unclonable function (PUF) material in a particle form that creates a magnetic field, or magnetic fingerprint, that can be interrogated by a sensor device, wherein the PUF material is distributed and dense enough to make it impractical to copy;
configuring the PUF material such that if it is removed from the object parts of the label is separated leaving some PUF material on the object and other on the label;
enrolling the magnetic fingerprint of the PUF label on the bottle by recording the magnetic field for one or more circumferential bands around the surface of the bottle's neck, storing the enrollment data, and using the recorded magnetic field as a magnetic fingerprint to authenticate the bottle;
using a kiosk-type fixture with a rotatable surface at the base that the bottle is placed and centered on, one or more three-axis magnetic sensors are advanced into near contact with the PUF tamper proof seal near the top of the bottle;
rotating the bottle to establish a magnetic field profile; and
comparing the measured profile against the enrollment data to authenticate the bottle.

7. The method of claim 6, wherein the bottle is rotated at least 360 degrees.

8. The method of claim 6, wherein the bottle remains stationary and the one or more sensors are moved across the surface of the magnetic PUF seal material to establish the magnetic field profile.

9. The method of claim 6, wherein the bottle is laid horizontally on rollers, or other similar device or mechanism, and rotated about the axis of the bottle while the magnetic fingerprint signals are collected from a stationary sensor location.

10. The method of claim 6, wherein when the bottle is authenticated, information is transmitted back to the kiosk-type fixture confirming the authenticity of the bottle, and a certificate of authenticity may be either displayed on a screen or printed.

11. A tamper proof label for sealing an object comprising:
a physically unclonable function (PUF) material integrated in the label that creates a magnetic fingerprint that can be interrogated by a sensor device;
at least two rows of punched areas that become a tear location when the object is opened;
multiple layers in the label, including a rigid or film substrate as an upper layer of the label that contains PUF material, an adhesive layer with the PUF material distributed within an adhesive, release layers that causes the adhesive to separate at lower force levels than the force levels required to remove the remaining areas of the label.

12. The tamper proof label of claim 11, wherein the substrate can be uniquely enrolled.

13. The tamper proof label of claim 12, wherein the adhesive can be characterized and enrolled with the label substrate.

14. The tamper proof label of claim 11, wherein the object is a bottle.
